(19) United States
(12) Patent Application Publication
(10) Pub. No.: US 2026/0145635 A1
(43) Pub. Date: May 28, 2026

(54) PASSENGER SEAT AIRBAG DEVICE

(71) Applicant: TOYODA GOSEI CO., LTD., Kiyosu-shi (JP)

(72) Inventors: Hiroki YOSHIDA, Aichi (JP); Shota WATANABE, Aichi (JP)

(21) Appl. No.: 19/395,183

(22) Filed: Nov. 20, 2025

(30) Foreign Application Priority Data
Nov. 25, 2024 (JP) 2024-204753

(51) Int. Cl. B60R 21/233; B60R 21/205; B60R 21/235

(52) U.S. Cl. CPC B60R 21/233; B60R 21/205; B60R 21/235; B60R 2021/23509

(57) ABSTRACT

An airbag of a passenger seat airbag device includes a lower portion which is inflated to protrude rearward from a storage portion, and an upper portion which is communicated with the lower portion via a communication hole and is inflated on an upper side of the lower portion. The upper portion is configured, at a time of full inflation, such that a front lower surface is abutted against an instrument panel, an upper surface is abutted against a front windshield, and a rear lower surface is supported by the lower portion. The lower portion is configured such that an area on a rear end side at the time of full inflation is thicker than an area on a front end side, and an upper surface is inclined rearward and upward with respect to a horizontal direction at the time of full inflation as viewed from left and right sides.

### CROSS-REFERENCE TO RELATED APPLICATIONS

This application is based on and claims priority under 35 USC 119 from Japanese Patent Application No. 2024-204753 filed on November 25, 2024, the entire content of which is incorporated herein by reference.

### TECHNICAL FIELD

The present disclosure relates to a passenger seat airbag device capable of protecting an occupant seated in a passenger seat.

### BACKGROUND ART

In the related art, as a passenger seat airbag device, there has been a configuration in which an airbag is folded and stored in a storage portion disposed on a lower side of an instrument panel. In this passenger seat airbag device of the related art, the airbag is inflated so as to be deployed forward and upward while protruding rearward from the storage portion by causing inflation gas discharged from an inflator to flow therein, and is disposed so as to widely cover the front of the occupant seated in the passenger seat in an upper-lower direction when fully inflated (for example, see JP2024-024685A). Specifically, in this passenger seat airbag device of the related art, the airbag covers a rear surface side of the instrument panel, and is disposed such that an upper end side thereof abuts against a front windshield disposed above the instrument panel, when fully inflated, and the airbag is configured to protect an upper body of the occupant by an area thereof on an upper side when fully inflated.

However, in the passenger seat airbag device of the related art, although an inner area of the airbag that has been fully inflated is partitioned by partitioning members, the airbag is formed in an integral bag shape from the upper end side to a lower end side. Therefore, it is difficult to stably support the area on the upper side by an area on a lower side at the time of full inflation, and there is a possibility that the upper body of the occupant cannot be accurately protected by the area on the upper side.

### SUMMARY OF INVENTION

An object of the present disclosure is to provide a passenger seat airbag device capable of accurately protecting an occupant by an airbag that been fully inflated even in a configuration in which the airbag is stored on a lower side of an instrument panel.

An aspect of the present disclosure relates to a passenger seat airbag device having:

a storage portion disposed on a lower side of an instrument panel in a vehicle;

an airbag to be folded and stored in the storage portion; and

an inflator configured to supply inflation gas to the airbag, in which

the airbag into which the inflation gas flows is inflated to protrude rearward from the storage portion and be deployed forward and upward,

the airbag includes a lower inflation portion connected to the inflator and configured to be inflated to protrude rearward from the storage portion, and an upper inflation portion communicated with the lower inflation portion via a communication hole and configured to be inflated on an upper side of the lower inflation portion, in which the lower inflation portion and the upper inflation portion are formed in separate bag shapes, and the lower inflation portion and the upper inflation portion are configured to be coupled each other by being joined to each other at a peripheral edge portion of the communication hole,

the upper inflation portion is a portion that protects an upper body of an occupant seated in a passenger seat, and is configured, at a time of full inflation, such that a front lower surface side is abutted against the instrument panel, an upper surface side is abutted against a front windshield disposed above the instrument panel, and an area on a rear lower surface side constituting a periphery of the communication hole is supported by the lower inflation portion, and

the lower inflation portion is configured such that an area on a rear end side at the time of full inflation is thicker than an area on a front end side located on a side of the storage portion, and an upper surface supporting the area on the rear lower surface side of the upper inflation portion is inclined rearward and upward with respect to a horizontal direction at the time of full inflation as viewed from left and right sides.

According to the aspect of the present disclosure, the airbag includes the upper inflation portion and the lower inflation portion which are formed in separate bag shapes and communicate with each other via the communication hole, and the upper inflation portion is configured to be inflated by causing the inflation gas flowing into the lower inflation portion to flow therein via the communication hole. In addition, the upper inflation portion and the lower inflation portion are coupled each other by being joined to each other at the peripheral edge portion of the communication hole. That is, in the passenger seat airbag device according to the present disclosure, at an initial stage of inflation of the airbag, first, the lower inflation portion is inflated so as to protrude rearward from the storage portion by causing the inflation gas discharged from the inflator to flow therein, and then the upper inflation portion is inflated by causing the inflation gas to flow therein through the communication hole. When the upper inflation portion is inflated, the inflation of the lower inflation portion is substantially full, and in the lower inflation portion, the upper surface side, which is a surface on the upper inflation portion side (the area constituting the periphery of the communication hole), is disposed to be inclined rearward and upward with respect to the horizontal direction as viewed from the left and right sides. Therefore, the upper inflation portion can be inflated so as to protrude forward and upward by being pushed by the upper surface of the lower inflation portion (the area of the periphery of the communication hole), and can be quickly brought into contact with the front windshield and the upper surface of the instrument panel. Further, even when the airbag is fully inflated, since the lower inflation portion supporting the rear lower surface side of the upper inflation portion inclines the upper surface in contact with the upper inflation portion rearward and upward with respect to the horizontal direction, the inclination of the upper surface of the lower inflation portion causes a force that inclines the entire upper inflation portion forward and downward (causes the front end to be directed downward) to act on the upper inflation portion that has be fully inflated, and the upper inflation portion is pressed against the upper surface side of the instrument panel over the area on the front end side at the time of full inflation. Therefore, a front lower surface of the upper inflation portion can be stably abutted against the upper surface of the instrument panel over the entire area in the front-rear direction.

According to the aspect of the present disclosure, since the lower inflation portion is formed of a bag body separate from the upper inflation portion, the upper inflation portion can be supported by bringing the areas of the periphery of the communication holes into contact with each other at the time of full inflation. In addition, since the area of the lower inflation portion on the rear end side at the time of full inflation is thicker than the area of the lower inflation portion on the front end side, the rear lower surface side of the upper inflation portion can be stably supported by the area on the rear end side that is inflated to be thick, and the upper inflation portion can also be prevented from moving so as to collapse rearward and downward in a state before the occupant is received.

That is, in the passenger seat airbag device according to the aspect of the present disclosure, even in a configuration in which the airbag is stored on the lower side of the instrument panel and is inflated so as to be deployed forward and upward while protruding rearward, the upper inflation portion of the airbag can be quickly inflated so as to abut against the upper surface of the instrument panel and the front windshield, the contact state with the upper surface of the instrument panel can be stably maintained when the upper inflation portion is fully inflated, and the upper inflation portion can also be prevented from moving so as to collapse rearward and downward after the full inflation. As a result, the upper body of the occupant can be stably protected by the upper inflation portion supported by the upper surface of the instrument panel, the front windshield, and the lower inflation portion.

Therefore, in the passenger seat airbag device according to the aspect of the present disclosure, even in a configuration in which the airbag is stored on the lower side of the instrument panel, the occupant can be accurately protected by the airbag that has been fully inflated.

In the passenger seat airbag device according to the aspect of the present disclosure, the upper inflation portion includes a pair of left and right upper wall panels disposed to face each other in a left-right direction side at the time of full inflation, the lower inflation portion includes a pair of left and right lower wall panels disposed to face each other in the left-right direction side at the time of full inflation, and a separation distance from a point of the lower wall panel on which a center of the communication hole is projected to a rear edge of the lower wall panel in a state of being flatly deployed is set to be larger than a separation distance from a point of the upper wall panel on which the center of the communication hole is projected to a rear edge of the upper wall panel in a state of being flatly deployed.

When the passenger seat airbag device is configured as described above, the lower inflation portion can widely cover the area located behind the communication hole on the rear lower surface side of the upper inflation portion at the time of full inflation over the rear end by making the area located rearward of the communication hole wider in the front-rear direction at the time of full inflation. In other words, the area on the rear lower surface side of the upper inflation portion can be supported widely in the front-rear direction toward the rear end side by the lower inflation portion. Therefore, it is possible to more accurately prevent a behavior of the upper inflation portion moving so as to collapse rearward and downward in the state before the occupant is received.

In the passenger seat airbag device according to the aspect of the present disclosure, the upper inflation portion has a flow regulating fabric therein, the flow regulating fabric covering a periphery of the communication hole to regulate a flow of the inflation gas flowing into the upper inflation portion through the communication hole, and the flow regulating fabric is formed in a substantially tubular shape to cover an upper side of the communication hole while opening both left and right end sides, and a front surface side of the flow regulating fabric is provided with a gas outflow hole through which the inflation gas flows out.

When the passenger seat airbag device is configured as described above, since the inflation gas flowing into the upper inflation portion can be prevented from flowing rearward and can flow forward and upward, the upper inflation portion can be more quickly inflated so as to protrude forward and upward, and start of the contact with the front windshield or the upper surface of the instrument panel can be accelerated. In addition, since the inflation gas flowing into the upper inflation portion is prevented from flowing rearward by the flow regulating fabric, it is also possible to prevent the upper inflation portion from being inflated so as to greatly protrude toward the rear side which is the occupant side. Therefore, the upper inflation portion can be prevented from swinging in the front-rear direction when deployed, and can be quickly fully inflated so as to protect the occupant.

### BRIEF DESCRIPTION OF DRAWINGS

Exemplary embodiment(s) of the present invention will be described in detail based on the following figures, wherein:

FIG. 1 is a schematic longitudinal sectional view of a passenger seat airbag device according to an embodiment of the present disclosure in a state of being mounted on a vehicle;

FIG. 2 is a schematic enlarged longitudinal sectional view of the passenger seat airbag device according to the embodiment;

FIG. 3 is a schematic perspective view showing a state where an airbag to be used in the passenger seat airbag device according to the embodiment is inflated alone;

FIG. 4 is a left side view of the airbag of FIG. 3;

FIG. 5 is a plan view of the airbag of FIG. 3 as viewed from above;

FIG. 6 is a back view of the airbag of FIG. 3 as viewed from the rear;

FIG. 7 is a schematic longitudinal sectional view of the airbag of FIG. 3 taken along a front-rear direction;

FIG. 8 is a schematic partial longitudinal sectional view of the airbag of FIG. 3 taken along a left-right direction, showing a portion of a communication hole;

FIG. 9 is a schematic partial transverse sectional view of the airbag of FIG. 3, showing the portion of the communication hole;

FIG. 10 is a plan view of the airbag of FIG. 3 in a state where base members constituting an upper inflation portion are arranged;

FIG. 11 is a plan view of the airbag of FIG. 3 in a state where the base member constituting a lower inflation portion, the base member constituting a flow regulating fabric, and the base member constituting a tether are arranged;

FIG. 12 is a plan view of the airbag of FIG. 3 in a state where an upper wall panel on a left side and a lower wall panel on the left side are arranged;

FIGS. 13A and 13B are schematic longitudinal sectional views showing an inflation process of the airbag in the passenger seat airbag device according to the embodiment;

FIGS. 14A and 14B are schematic longitudinal sectional views showing the inflation process of the airbag in the passenger seat airbag device according to the embodiment, and shows a process after FIG. 13B;

FIG. 15 is a schematic longitudinal sectional view showing a fully inflated state of the airbag in the passenger seat airbag device according to the embodiment; and

FIG. 16 is a partially enlarged sectional view showing an area of a lower inflation portion in FIG. 15.

### DESCRIPTION OF EMBODIMENTS

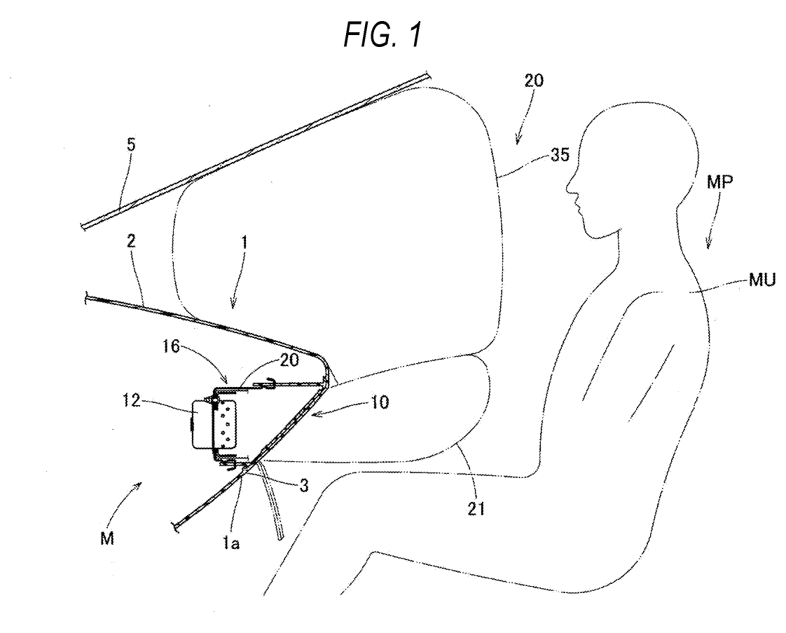

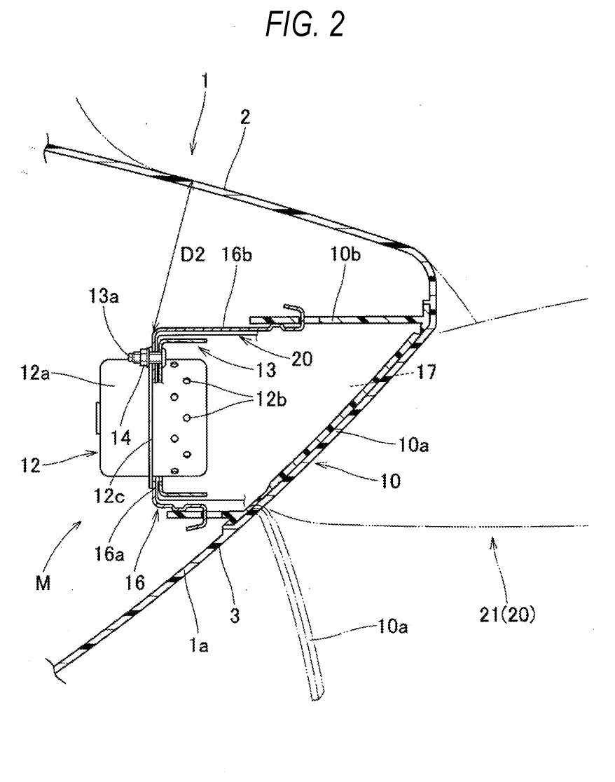

Hereinafter, an embodiment of the present disclosure will be described with reference to the drawings. As shown in FIGS. 1 and 2, a passenger seat airbag device (hereinafter abbreviated as "airbag device") M according to the embodiment is disposed on a rear surface 3 side which is a lower portion 1a side of an instrument panel 1. In the embodiment, front-rear, upper-lower, and left-right directions coincide with front-rear, upper-lower, and left-right directions of a vehicle unless otherwise specified.

As shown in FIGS. 1 and 2, the airbag device M includes a case 16 as a storage portion disposed on the lower portion 1a side of the instrument panel 1, an airbag 20 to be folded and stored in the case 16, an inflator 12 that supplies inflation gas to the airbag 20, a retainer 13 for attaching the airbag 20 and the inflator 12 to the case 16, and an airbag cover 10 that covers the folded airbag 20.

The airbag cover 10 is formed so as to be continuous with the instrument panel 1, is made of synthetic resin, and includes one door portion 10a that opens when the airbag 20 is deployed and inflated. In the case of the embodiment, the door portion 10a is configured to open downward by being pushed by the airbag 20. A coupling wall portion 10b coupled to the case 16 is formed around the door portion 10a of the airbag cover 10 so as to protrude forward.

As shown in FIG. 2, the inflator 12 includes a substantially columnar main body portion 12a having a plurality of gas discharge ports 12b, and a flange portion 12c for

attaching the inflator 12 to the case 16. In the airbag device M according to the embodiment, the inflator 12 is attached to a front end side (bottom wall portion 16a) of the case 16 such that an axial direction of the main body portion 12a is along the front-rear direction.

The case 16 as the storage portion is formed in a substantially rectangular parallelepiped shape having a rectangular opening on a rear end side, and as shown in FIG. 2, includes a substantially rectangular bottom wall portion 16a to which the inflator 12 is inserted and attached from the front, and a peripheral wall portion 16b extending rearward from an outer periphery of the bottom wall portion 16a and locking the coupling wall portion 10b of the airbag cover 10. The case 16 is disposed on the lower portion 1a side of the instrument panel 1 (a position separated from an upper surface 2 of the instrument panel 1), specifically, at a position above and in front of knees of an occupant MP seated in a passenger seat, such that the axial direction is along the front-rear direction (horizontal direction) (see FIG. 1). The opening provided on the rear end side of the case 16 constitutes a protrusion opening 17 through which the airbag 20, which is inflated by causing the inflation gas to flow therein, can protrude rearward. In the case of the embodiment, the airbag 20 and the inflator 12 are attached to the bottom wall portion 16a of the case 16 by passing bolts 13a of the retainer 13 disposed in the airbag 20 through a periphery of an inflow opening 26 to be described later in the airbag 20, the bottom wall portion 16a of the case 16, and the flange portion 12c of the inflator 12, as an attachment unit, and fastening them with nuts 14. The case 16 is coupled to a body side of the vehicle using a bracket (not shown).

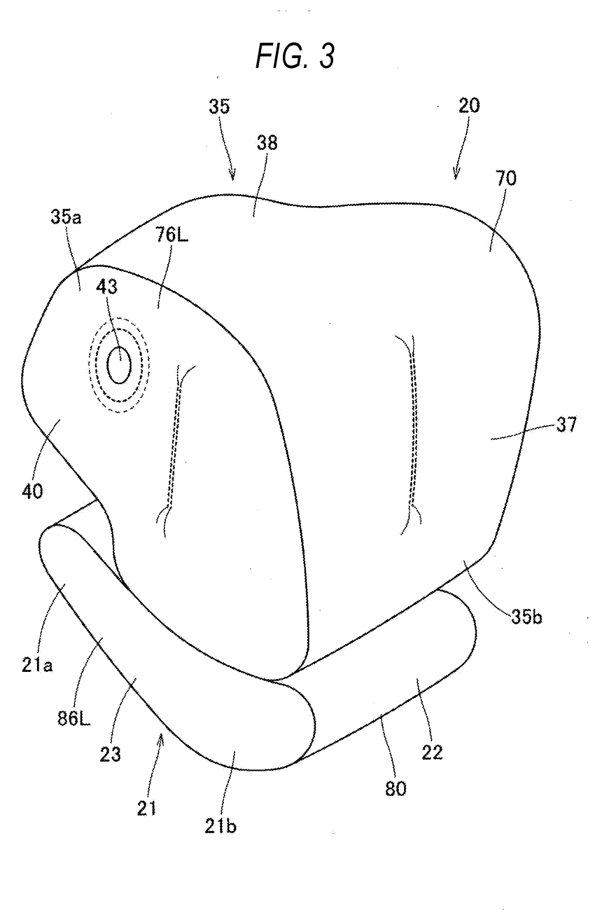

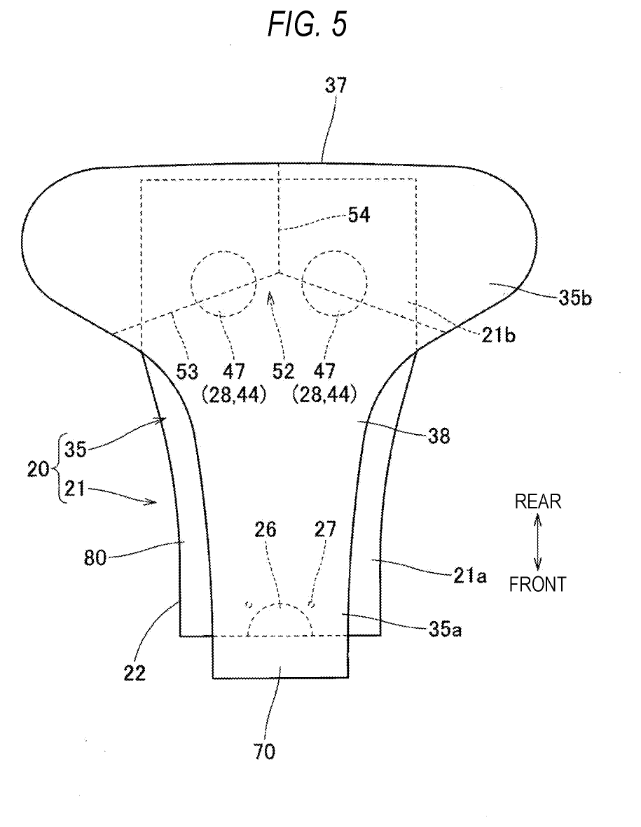

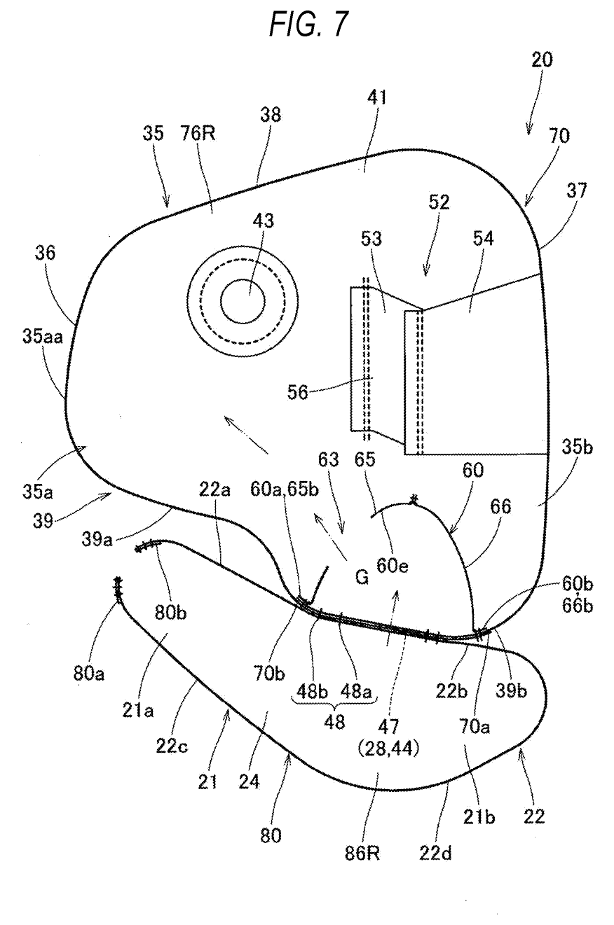

The airbag 20 is formed of a flexible sheet body, and as shown in FIGS. 3 to 7, includes an upper inflation portion 35 and a lower inflation portion 21 which are formed in separate bag shapes. The upper inflation portion 35 and the lower inflation portion 21 communicate with each other via a communication hole 47, and are coupled each other by being joined to each other at a peripheral edge portion of the communication hole 47 (see FIGS. 7 to 9). In the airbag 20 according to the embodiment, a tether 52 that restricts a fully inflated shape of the upper inflation portion 35 and a flow regulating fabric 60 that can regulate a flow of inflation gas G flowing into the upper inflation portion 35 are disposed inside the upper inflation portion 35 (see FIGS. 5, 7 and 10).

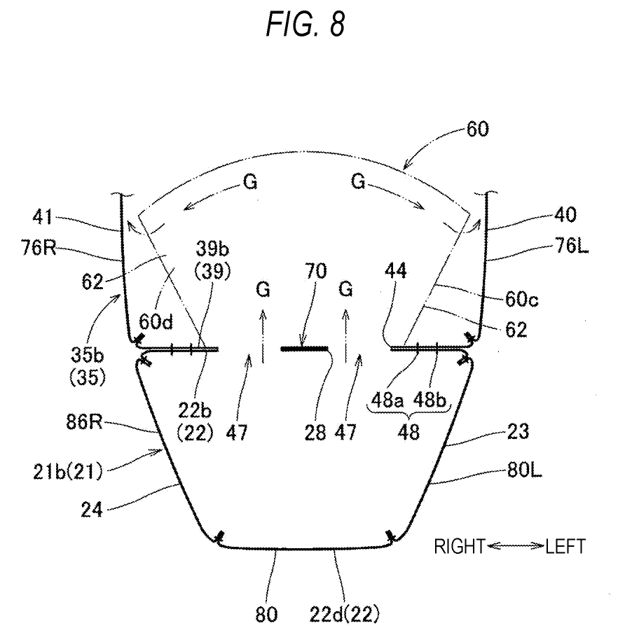

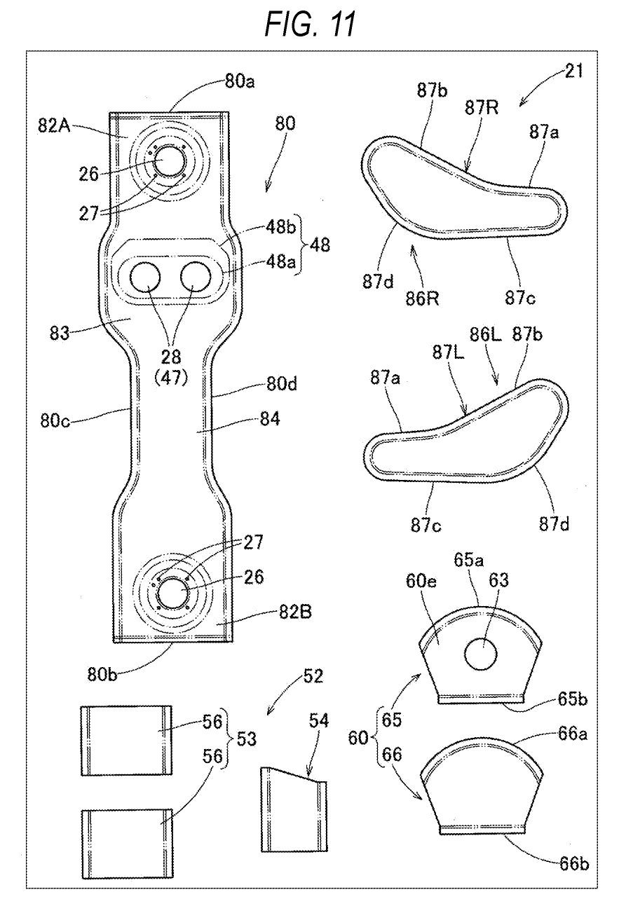

The lower inflation portion 21 is a portion that is connected to the inflator 12 and is inflated so as to protrude rearward from the case 16. As shown in FIGS. 3 to 6, the lower inflation portion 21 has a substantially rectangular plate-like fully inflated shape. The lower inflation portion 21 includes a left wall portion 23 and a right wall portion 24 that are disposed so as to face each other on the left-right direction side at the time of full inflation, and a peripheral wall portion 22 that couples the left wall portion 23 and the right wall portion 24 to each other and constitutes an area extending in the front-rear and upper-lower directions at the time of full inflation. An inflow opening 26 that opens in a substantially circular shape so as to allow the inflation gas to flow therein and has a periphery attached to the bottom wall portion 16a of the case 16 is formed at a substantially center position in the left-right direction on a front end side of the peripheral wall portion 22 (see FIGS. 5 and 7). A plurality of (four in the embodiment) attachment holes 27 for attaching the periphery of the inflow opening 26 to the bottom wall portion 16a of the case 16 by inserting the bolts 13a of the retainer 13 are formed in the periphery of the inflow opening 26 (see FIGS. 5 and 11). In the peripheral wall portion 22, an opening 28 constituting the communication hole 47 is formed at a position (a rear upper portion 22b, which is an upper surface side of a rear area 21b to be described later) slightly rearward of a center in the front-rear direction of an upper portion constituting an upper surface side of the lower inflation portion 21 (see FIG. 8). In the case of the embodiment, the openings 28 open in a circular shape, and two openings 28 are arranged side by side in the left-right direction side (see FIGS. 5, 9 and 11).

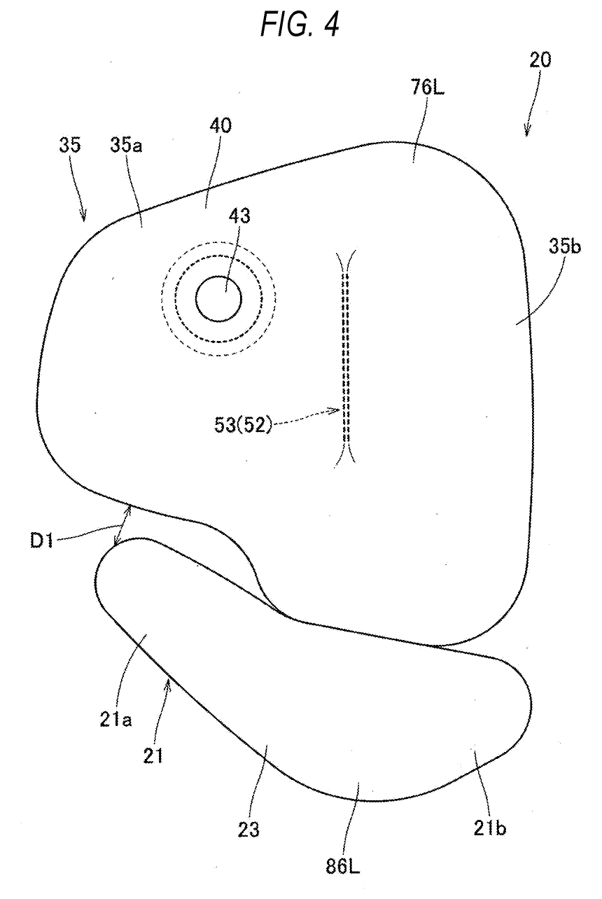

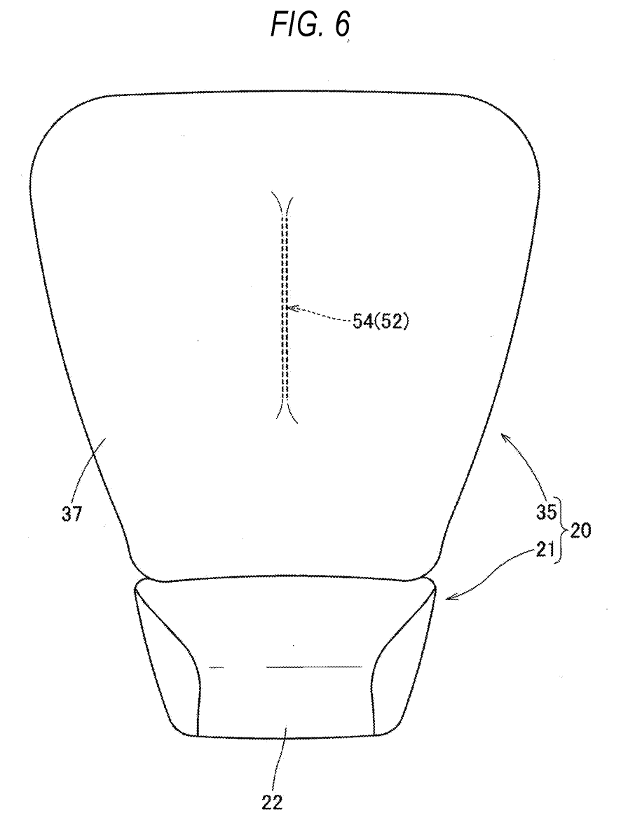

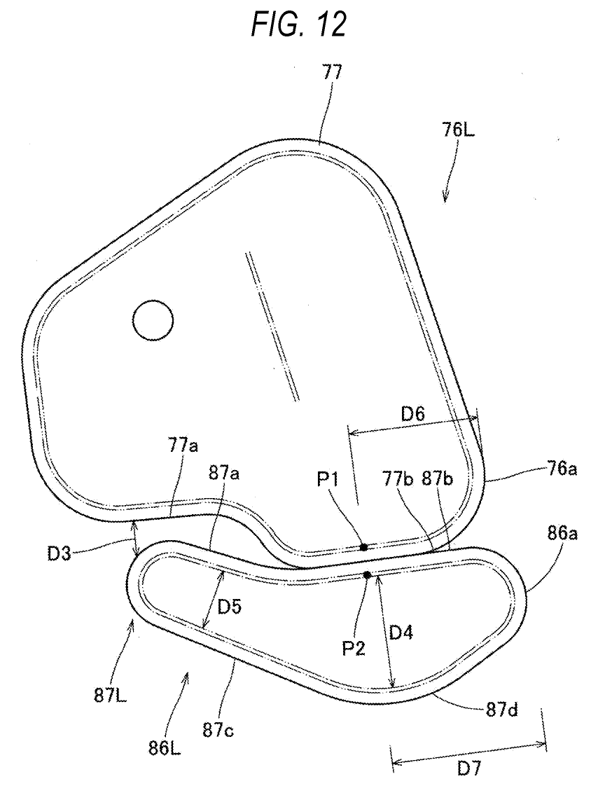

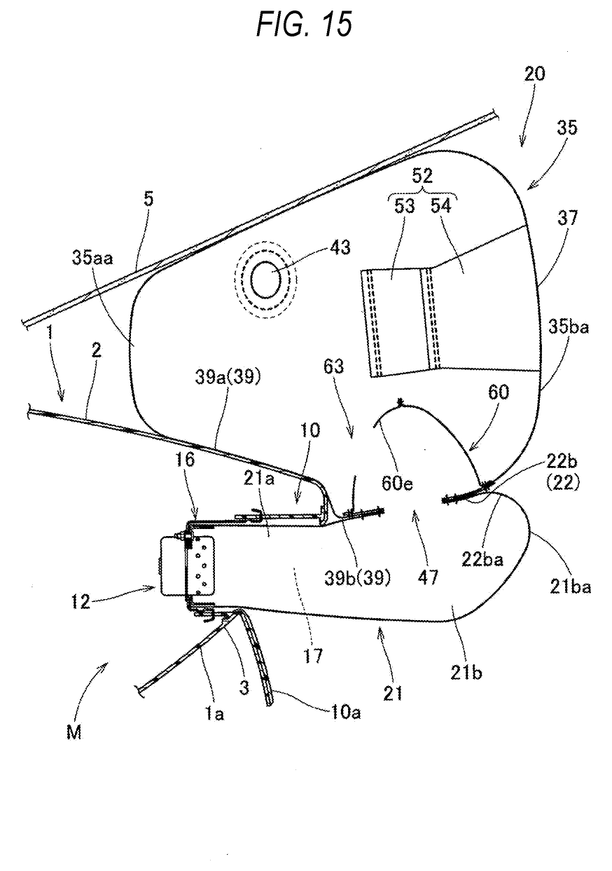

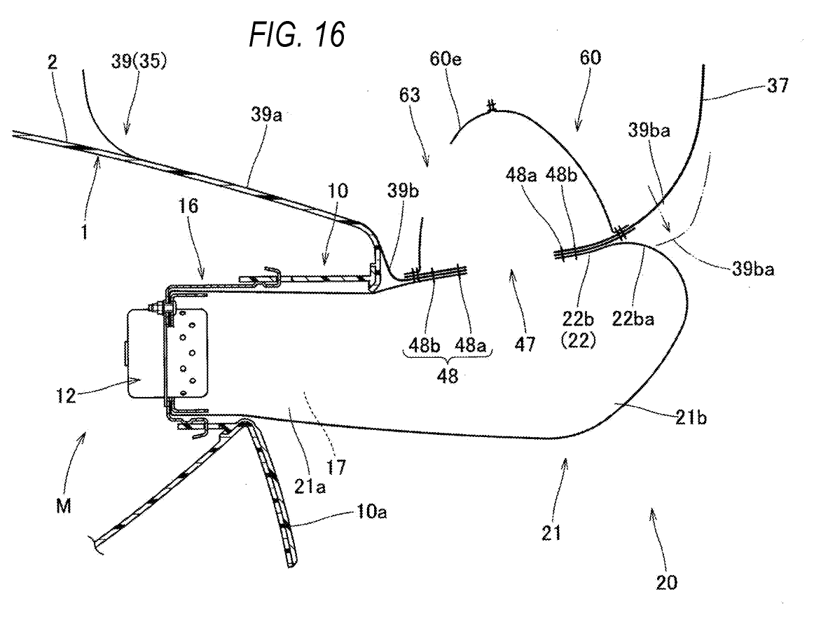

The lower inflation portion 21 includes a front area 21a that is disposed in the case 16 at the time of full inflation, and the rear area 21b that is disposed behind the front area 21a and below the upper inflation portion 35 at the time of full inflation (see FIGS. 7 and 16). The inflow opening 26 and the attachment hole 27 described above are disposed on the front end side of the front area 21a, and the opening 28 constituting the communication hole 47 is disposed on the upper surface side of the rear area 21b (see FIG. 7). In the airbag 20 according to the embodiment, as shown in FIGS. 15 and 16, the lower inflation portion 21 is configured such that the front area 21a is disposed along the front-rear direction (horizontal direction) and the rear area 21b is disposed so as to be inclined rearward and upward with respect to the front-rear direction (horizontal direction) in a state where the fully inflated state when the airbag device is mounted on the vehicle is viewed from the left and right sides. The front area 21a has a substantially constant width dimension (width dimension in the left-right direction) over the entire area in the front-rear direction and a substantially constant thickness dimension over the entire area in the front-rear direction at the time of full inflation in a state of being inflated alone (see FIGS. 4, 5 and 7). A thickness dimension of the rear area 21b at the time of full inflation is set to be larger than the thickness dimension of the front area 21a at the time of full inflation (see FIGS. 4 and 7). Further, in the rear area 21b, the upper surface at the time of full inflation (the rear upper portion 22b which is an area where the opening 28 constituting the communication hole 47 is disposed in the peripheral wall portion 22) is also inclined rearward and upward with respect to the horizontal direction in a state where the fully inflated state when the airbag is mounted on the vehicle is viewed from the left and right sides (see FIGS. 15 and 16). A difference in thickness between the front area 21a and the rear area 21b and the inclination of the rear area 21b are caused by outer shapes of a pair of left and right lower wall panels 86L, 86R (see FIGS. 11 and 12), which will be described later, constituting the left wall portion 23 and the right wall portion 24 in the lower inflation portion 21, which will be described later in detail. The rear upper portion 22b constituting the upper surface of the rear area is disposed to be inclined rearward and upward with respect to the horizontal direction in a state where the airbag 20 is viewed from left and right lateral sides when the airbag 20 in the state of being mounted on the vehicle is fully inflated (see FIGS. 15 and 16). In addition, the rear area 21b is configured to support a rear lower end side of the upper inflation portion 35 when the airbag 20 is fully inflated, and is configured such that the width dimension in the left-right direction side of the upper surface side (the rear upper portion 22b) coincides with a width dimension in the left-right direction side of a rear lower surface (rear portion 39b of a lower wall portion 39 to be described later) of the upper inflation portion 35 (see FIGS. 6 and 8). Further, as shown in FIG. 5, the rear area 21b is configured to be disposed at a position where a rear end 21ba substantially coincides with a rear end 35ba of the upper inflation portion 35 in the front-rear direction when the airbag 20 is fully inflated. Furthermore, the rear area 21b has a substantially trapezoidal shape in which the fully inflated shape as viewed from the rear side is narrowed downward (see FIGS. 6 and 8). In the airbag 20 according to the embodiment, the upper inflation portion 35 is also configured such that the fully inflated shape as viewed from the rear side narrows downward, and the rear area 21b is configured such that a left edge and a right edge of the fully inflated shape as viewed from the rear side are continuous with an outline of the upper inflation portion 35 (see FIG. 6).

The upper inflation portion 35 is a portion that protects an upper body MU of the occupant MP seated in the passenger seat as a bag shape communicating with the lower inflation portion 21 via the communication hole 47, and is disposed so as to close between the upper surface 2 of the instrument panel 1 and the front windshield 5 disposed above the instrument panel 1 at the time of full inflation, and a rear lower surface side thereof is supported by the lower inflation portion 21 (see FIG. 15). As shown in FIGS. 3 to 7, the upper inflation portion 35 includes a front wall portion 36 and a rear wall portion 37 facing each other in the front-rear direction side at the time of full inflation, an upper wall portion 38 and the lower wall portion 39 facing each other in the upper-lower direction side at the time of full inflation, and a left wall portion 40 and a right wall portion 41 facing each other in the left-right direction side at the time of full inflation. Further, in the airbag 20 according to the embodiment, the upper inflation portion 35 is configured such that the rear area 35b (area on the rear wall portion 37 side) disposed on the occupant MP side when the airbag 20 is fully inflated is wide in the left-right direction so as to accurately protect the upper body MU of the occupant MP, and the front area 35a disposed on the front side is narrow in the left-right direction (see FIG. 5). A width dimension of the front area 35a in the left-right direction side at the time of full inflation is set to about 1/3, which is a width dimension of the widest area of the rear area 35b (an upper end side of the rear wall portion 37) in the left-right direction side. As shown in FIG. 5, the width dimension of the front area 35a in the left-right direction side at the time of full inflation is set to be smaller than the width dimension of the front area 21a in the lower inflation portion 21 in the left-right direction side.

In the upper inflation portion 35, the rear wall portion 37 is disposed substantially along the upper-lower direction in front of the upper body MU of the occupant MP seated in the passenger seat when the airbag 20 is fully inflated, and is a portion that receives and protects the upper body MU of the occupant MP moving forward. A width dimension of the rear wall portion 37 in the upper-lower direction and left-right direction is set to a dimension capable of receiving and protecting the upper body MU of the occupant MP. Specifically, an outer shape of the rear wall portion 37 as viewed from the rear is a substantially inverted trapezoidal shape in which an upper side thereof is wide in the left-right direction and a lower end side thereof is narrow (see FIG. 6). The upper wall portion 38 is a portion that is disposed to be inclined forward and downward when the airbag 20 is fully inflated and abuts against the front windshield 5. A front portion 39a of the lower wall portion 39 is a portion that abuts against the upper surface 2 of the instrument panel 1 when the airbag 20 is fully inflated (see FIGS. 15 and 16). The rear portion 39b of the lower wall portion 39 is disposed so as to be located one step lower than the front portion 39a when the airbag 20 is fully inflated, and is a portion disposed in contact with the rear upper portion 22b of the peripheral wall portion 22 of the lower inflation portion 21 (see FIGS. 7, 15 and 16). The front wall portion 36 is a portion disposed substantially along the upper-lower direction so as to couple a front end of the upper wall portion 38 and a front end of the front portion 39a of the lower wall portion 39. In the airbag 20 according to the embodiment, the width is narrow from the front portion 39a of the lower wall portion 39 to a front portion of the upper wall portion 38 via the front wall portion 36, and a rear portion of the upper wall portion 38 is configured such that the width dimension gradually increases toward the rear wall portion 37. In the airbag 20 according to the embodiment, the front wall portion 36 (a front end 35aa of the upper inflation portion 35 at the time of full inflation) is located in front of a front end (the inflow opening 26) of the lower inflation portion 21 (see FIG. 7). That is, as shown in FIG. 15, the upper inflation portion 35 is configured such that the front end 35aa is located in front of the case 16 when the airbag 20 is fully inflated. In the left wall portion 40 and the right wall portion 41, vent holes 43, 43 for discharging excess inflation gas flowing into the upper inflation portion 35 are formed to be opened in a substantially circular shape. Each vent hole 43 is disposed at a position in the vicinity of a front upper edge in the left wall portion 40 and the right wall portion 41 (a position in front of the tether 52 to be described later, and in the front area 35a in the upper inflation portion 35).

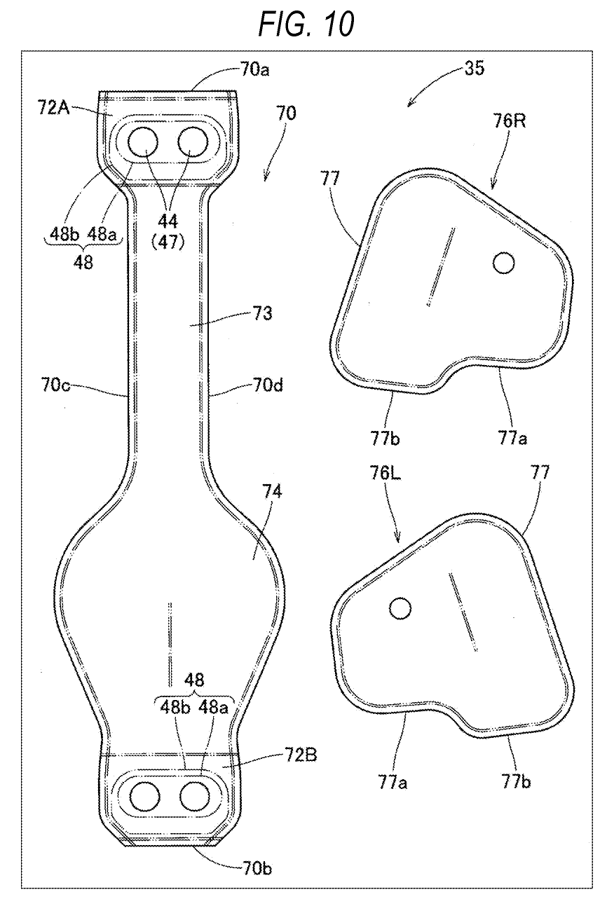

In the rear portion 39b of the lower wall portion 39 (an area on a lower surface side of the rear area 35b in the upper inflation portion 35, which is an area supported by the lower inflation portion 21 at the time of full inflation), openings 44 constituting the communication holes 47 are formed corresponding to the openings 28 formed in the rear upper portion 22b of the peripheral wall portion 22 in the lower inflation portion 21 (see FIGS. 8 and 10). The openings 44 are opened in a circular shape, and two openings 44 are arranged side by side in the left-right direction side. That is, in the airbag 20 according to the embodiment, two communication holes 47 that allow the upper inflation portion 35 and the lower inflation portion 21 to communicate with each other are arranged side by side in the left-right direction side. Specifically, in a state where the airbag 20 is inflated, the communication holes 47 are formed at two positions that are bilaterally symmetrical with respect to the center of the airbag 20 in the left-right direction (see FIGS. 5, 8 and 9).

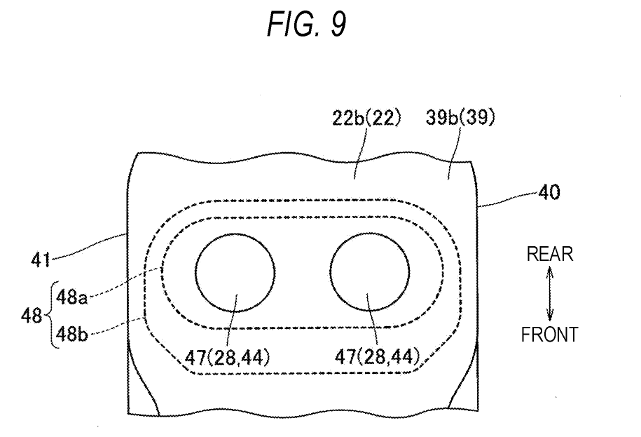

The upper inflation portion 35 and the lower inflation portion 21 are coupled each other by sewing the rear portion 39b of the lower wall portion 39 and the rear upper portion 22b of the peripheral wall portion 22 at the periphery of the communication hole 47 (the peripheries of the respective openings 28, 44) using a sewing thread. In the case of the embodiment, as shown in FIG. 9, a sewn portion 48 coupling the upper inflation portion 35 and the lower inflation portion 21 (the rear portion 39b and the rear upper portion 22b) is doubly formed so as to surround the two communication holes 47. Specifically, in the sewn portion 48, an inner portion 48a disposed on an inner side has an oval shape wide in the left-right direction so as to surround the two communication holes 47. An outer portion 48b disposed on an outer side has a substantially rectangular shape that surrounds a periphery of the inner portion 48a and separates an area on a front side (an area on the front side of the communication hole 47) at the time of full inflation from the inner portion 48a more than an area on the rear side. More specifically, the width dimension in the left-right direction side of the outer portion 48b is set to be slightly narrower than the width dimension in the left-right direction side of the rear portion 39b of the lower wall portion 39 of the upper inflation portion 35 and the width dimension in the left-right direction side of the rear upper portion 22b of the peripheral wall portion 22 of the lower inflation portion 21 (see FIGS. 8 to 11). That is, in the airbag 20 according to the embodiment, the upper inflation portion 35 and the lower inflation portion 21 are coupled each other by joining the rear portion 39b of the lower wall portion 39 and the rear upper portion 22b of the peripheral wall portion 22, which constitute a periphery of the communication hole 47, to each other over substantially the entire area in the left-right direction by the sewn portion 48. In other words, in the airbag 20 according to the embodiment, the rear portion 39b of the lower wall portion 39 in the upper inflation portion 35 and the rear upper portion 22b of the peripheral wall portion 22 in the lower inflation portion 21 are integrated with each other by sewing the areas on the front side serving as the peripheries of the communication holes 47 to each other, and the rear portion 39b and the rear upper portion 22b are disposed to be inclined rearward and upward with respect to the horizontal direction when the airbag 20 is fully inflated while mounted on the vehicle (see FIG. 16).

Specifically, the tether 52 disposed in the upper inflation portion 35 is disposed in the rear area 35b of the upper inflation portion 35, and in the case of the embodiment, the tether 52 includes a left-right coupling portion 53 that couples the left wall portion 40 and the right wall portion 41, and a front-rear coupling portion 54 that couples the left-right coupling portion 53 and the rear wall portion 37, and is disposed in a substantially flat Y shape as viewed from the upper-lower direction side (see FIG. 5). The left-right coupling portion 53 is band-shaped body formed from a flexible sheet body, and both ends thereof are joined at positions slightly rearward of centers in the front-rear direction of the left wall portion 40 and the right wall portion 41 and near centers thereof in the upper-lower direction, such that the width direction of the left-right coupling portion 53 thereof is substantially along with the upper-lower direction. The left-right coupling portion 53 is bent and disposed such that a center in the left-right direction is located rearward when the upper inflation portion 35 is fully inflated. In the case of the embodiment, the left-right coupling portion 53 includes two tether base members 56, 56 configured to be divided into two on the left-right direction side (see FIG. 11). The front-rear coupling portion 54 is disposed so as to couple the center in the left-right direction of the left-right coupling portion 53 and substantially the center in the upper-lower direction and the left-right direction of the rear wall portion 37, is a band-shaped body formed of a flexible sheet body, and is disposed substantially along the front-rear direction when the upper inflation portion 35 is fully inflated, with the width direction thereof substantially along the upper-lower direction. In the case of the embodiment, the front-rear coupling portion 54 is configured such that a rear end side coupled to the rear wall portion 37 is slightly wider than a front end side coupled to the left-right coupling portion 53 (see FIGS. 7 and 11). The tether 52 is disposed to restrict excessive outward protrusion of the left wall portion 40 and the right wall portion 41 of the upper inflation portion 35 in the left-right direction and excessive rearward protrusion of the rear wall portion 37 when the airbag 20 is deployed and inflated, and to restrict a separation distance between the left wall portion 40 and the right wall portion 41, and to restrict excessive rearward protrusion of the rear wall portion 37 (restrict a separation distance between the left-right coupling portion 53 and the rear wall portion 37) when the airbag 20 is fully inflated.

The flow regulating fabric 60 disposed inside the upper inflation portion 35 is disposed so as to cover the periphery of the communication hole 47 (specifically, an area above the communication hole 47) inside the upper inflation portion 35 (see FIGS. 7 and 8). The flow regulating fabric 60 is configured to regulate the flow of the inflation gas flowing into the flow regulating fabric 60 through the communication hole 47, and specifically, the flow regulating fabric 60 is configured to regulate the flow of the inflation gas G flowing into through the communication hole 47 such that the inflation gas G flows outward to the left and right and forward. The flow regulating fabric 60 is configured such that a front edge 60a side and a rear edge 60b side are respectively sewn to the rear portion 39b of the lower wall portion 39 in the upper inflation portion 35 on the front side and the rear side of the communication holes 47 to cover the upper side of the communication holes 47, and gas outflow openings 62, 62 are respectively disposed on a left end 60c side and a right end 60d side. In the flow regulating fabric 60, a gas outflow hole 63 through which the inflation gas can flow out is disposed in a front area 60e disposed on the front side. In the case of the embodiment, one gas outflow hole 63 is opened in a circular shape and disposed at a center of a front member 65, which will be described later, constituting the flow regulating fabric 60 (see FIG. 11). In the embodiment, the flow regulating fabric 60 includes the front member 65 and a rear member 66 as shown in FIG. 11. Outer shapes of the front member 65 and the rear member 66 are set to be the same, and upper edges 65a, 66a are sewn to each other, and lower edges 65b, 66b are sewn to the rear portion 39b of the lower wall portion 39 to form the flow regulating fabric 60. The upper edges 65a, 66a of the front member 65 and the rear member 66 are curved in an arc shape such that the centers thereof protrude upward. In the flow regulating fabric 60 according to the embodiment, a front edge 60a and a rear edge 60b (the lower edges 65b, 66b of the front member 65 and the rear member 66) are sewn together to the rear portion 39b of the lower wall portion 39 at the time of sewing work of lower rear constituent portions 72A, 72B of an upper peripheral wall panel 70 to be described later (at the time of sewing work of end edges 70a, 70b) (see FIG. 7).

In the airbag 20 according to the embodiment, a separation distance D1 (see FIG. 4) between the front end (inflow opening 26) of the lower inflation portion 21 and the front portion 39a of the lower wall portion 39 of the upper inflation portion 35 when the airbag 20 in a state of being inflated alone is viewed from the left-right direction side is set to be smaller than a separation distance D2 (see FIG. 2) between the inflow opening 26 (that is, the front end of the case 16) of the airbag 20 and the front portion 39a of the lower wall portion 39 of the upper inflation portion 35 (that is, the upper surface 2 of the instrument panel 1) when the airbag 20 in a state of being mounted on the vehicle is viewed from the left-right direction side. An outer shape of the airbag 20 in a state of being inflated alone as viewed from the left and right sides will be described in detail later, but in the case of the embodiment, the outer shape thereof is mainly caused by outer shapes of the pair of left and right upper wall panels 76L, 76R constituting the left wall portion 40 and the right wall portion 41 of the upper inflation portion 35 and the pair of left and right lower wall panels 86L, 86R constituting the left wall portion 23 and the right wall portion 24 of the lower inflation portion 21.

In the airbag 20 according to the embodiment, the upper inflation portion 35 and the lower inflation portion 21 are each formed in a bag shape by joining peripheral edges of a base member (base fabric) having a predetermined shape to each other. The upper inflation portion 35 includes one upper peripheral wall panel 70 and a pair of left and right upper wall panels 76L, 76R, and the lower inflation portion 21 includes one lower peripheral wall panel 80 and a pair of left and right lower wall panels 86L, 86R (see FIGS. 10 and 11).

The upper peripheral wall panel 70 constitutes areas of the upper wall portion 38, the rear wall portion 37, the lower wall portion 39, and the front wall portion 36 in the upper inflation portion 35. As shown in FIG. 10, the upper peripheral wall panel 70 has a substantially band-like outer shape that is substantially symmetrical in the left-right direction, lower rear constituent portions 72A, 72B that constitute the rear portion 39b of the lower wall portion 39 (a peripheral edge portion of the communication hole 47) are disposed on both end sides thereof, and a narrow width portion 73 that constitutes a portion from the front portion 39a of the lower wall portion 39 to the front side of the upper wall portion 38 via the front wall portion 36 and a wide width portion 74 that constitutes an area from the rear side of the upper wall portion 38 to the rear wall portion 37 are disposed in series between the lower rear constituent portions 72A, 72B.

The pair of left and right upper wall panels 76L, 76R constitute the left wall portion 40 and the right wall portion 41 that face each other on the left-right direction side at the time of full inflation in the upper inflation portion 35, and the outer shapes thereof are symmetrical in the left-right direction (see FIG. 10). In outer peripheral edges 77L, 77R of the upper wall panels 76L, 76R, a lower front portion 77a constituting a left edge or a right edge of the front portion 39a of the lower wall portion 39 and a lower rear portion 77b constituting a left edge or a right edge of the rear portion 39b of the lower wall portion 39 are formed to be substantially parallel to each other while providing a step.

The upper inflation portion 35 is formed in a bag shape by sewing front and rear end edges 70a, 70b of the upper peripheral wall panel 70 such that the lower rear constituent portions 72A, 72B overlap each other, and sewing a left edge 70c and a right edge 70d of the upper peripheral wall panel 70 to outer peripheral edges 77L, 77R of the upper wall panels 76L, 76R, respectively (see FIGS. 7 and 8).

The lower peripheral wall panel 80 constitutes the peripheral wall portion 22 of the lower inflation portion 21, and as shown in FIG. 11, the lower peripheral wall panel 80 has a substantially band-like outer shape that is substantially symmetrical in the left-right direction. In the lower peripheral wall panel 80, front end constituent portions 82A, 82B that constitute an area on the front end side of the peripheral wall portion 22 (a peripheral edge portion of the inflow opening 26) are disposed on both end sides, and a rear upper surface constituent portion 83 that constitutes the rear upper portion 22b (the peripheral edge portion of the communication hole 47) in the peripheral wall portion 22 and a lower surface constituent portion 84 that constitutes an area from the rear end side to the lower surface side in the peripheral wall portion 22 are disposed in series between the front end constituent portions 82A, 82B. The lower surface constituent portion 84 is configured to have a narrow width at an intermediate portion in the front-rear direction.

The pair of left and right lower wall panels 86L, 86R constitute the left wall portion 23 and the right wall portion 24 that face each other on the left-right direction side at the time of full inflation in the lower inflation portion 21, and the outer shapes thereof are symmetrical in the left-right direction (see FIG. 11). In the outer peripheral edges 87L, 87R of the lower wall panels 86L, 86R, front upper portions 87a constituting an upper edge of the front area 21a (the left edge or the right edge of the front upper portion 22a of the peripheral wall portion 22) and rear upper portions 87b constituting the upper edge of the rear area 21b (the left edge or the right edge of the rear upper portion of the peripheral wall portion) are disposed to intersect at an obtuse angle. The front upper portion 87a is slightly inclined rearward and upward with respect to a front lower portion 87c constituting a lower edge of the front area 21a. That is, the rear upper portions 87b of the outer peripheral edges 87L, 87R are inclined rearward and upward with respect to the front upper portions 87a. In the outer peripheral edges 87L, 87R of the lower wall panels 86L, 86R, rear lower portions 87d constituting the lower edge of the rear area 21b are disposed so as to curve downward in a bulging manner with respect to the rear upper portion 87b formed in a substantially linear shape. A separation distance D4 between the vicinity of a center of the rear lower portion 87d and the rear upper portion 87b is set to be larger than a separation distance D5 between the front upper portion 87a and the front lower portion 87c (see FIG. 12).

The lower inflation portion 21 is formed in a bag shape by sewing front and rear end edges 80a, 80b of the lower peripheral wall panel 80 such that the front end constituent portions 82A, 82B overlap each other, and sewing a left edge 80c and a right edge 80d of the lower peripheral wall panel 80 to the outer peripheral edges 87L, 87R of the lower wall panels 86L, 86R, respectively (see FIGS. 7 and 8).

The outer shape of the airbag 20 in a state of being inflated alone as viewed from the left and right sides is caused by the outer shapes of the pair of left and right upper wall panels 76L, 76R constituting the left wall portion 40 and the right wall portion 41 of the upper inflation portion 35 and the pair of left and right lower wall panels 86L, 86R constituting the left wall portion 23 and the right wall portion 24 of the lower inflation portion 21, and as shown in FIG. 12, the outer shape thereof in a state where the lower rear portion 77b of the outer peripheral edge 77L of the upper wall panel 76L and the rear upper portion 87b of the outer peripheral edge 87L of the lower wall panel 86L are overlapped with each other in a state where the upper wall panel 76L and the lower wall panel 86L are flatly deployed approximates the outer shape of the airbag 20 in a state of being inflated alone as viewed from the left and right sides (specifically, the left side). As shown in FIG. 12, in the upper wall panel 76L and the lower wall panel 86L in a state where the lower rear portion 77b and the rear upper portion 87b are flatly deployed while being overlapped with each other, a separation distance D3 between the front end of the lower wall panel 86L and the lower front portion 77a in the outer peripheral edge 77L of the upper wall panel 76L is set to be smaller than the separation distance D2 between the front end (bottom wall portion 16a) of the case 16 and the upper surface 2 of the instrument panel 1 in a state where the case 16 is mounted on the vehicle. In the lower wall panel 86L, as described above, the separation distance D4 between the rear upper portion 87b and the rear lower portion 87d constituting the upper edge and the lower edge of the rear area 21b is set to be larger than the separation distance D5 between the front upper portion 87a and the front lower portion 87c constituting the upper edge and the lower edge of the front area 21a. In addition, a separation distance D6 from a point P1 of the upper wall panel 76L on which the center of the communication hole 47 is projected to the rear edge 76a of the upper wall panel 76L in a state of being flatly deployed is set to be smaller than a separation distance D7 from a point P2 of the lower wall panel 86L on which the center of the communication hole 47 is projected to the rear edge 86a of the lower wall panel 86L in the state of being flatly deployed (see FIG. 12).

In the embodiment, as shown in FIGS. 10 and 11, the upper peripheral wall panel 70, the upper wall panels 76L, 76R, the lower peripheral wall panel 80, and the lower wall panels 86L, 86R that constitute the airbag 20, the left-right coupling portion 53 (tether base members 56, 56) and the front-rear coupling portion 54 that constitute the tether 52, and the front member 65 and the rear member 66 that constitute the flow regulating fabric 60 are each formed of a flexible woven fabric made of polyester yarn, polyamide yarn, or the like.

In the airbag device M according to the embodiment, when the inflation gas is discharged from the gas discharge port 12b of the inflator 12 after being mounted on the vehicle, the airbag 20 is inflated by causing the inflation gas to flow therein, and pushes and opens the door portion 10a of the airbag cover 10. Then, the airbag 20 protrudes rearward from the case 16 through the protrusion opening 17 of the case 16 formed by pushing and opening the door portion 10a of the airbag cover 10, and is deployed and inflated while protruding forward and upward, so that the airbag is fully inflated as shown by a two-dot chain line in FIG. 1 and as shown in FIG. 15.

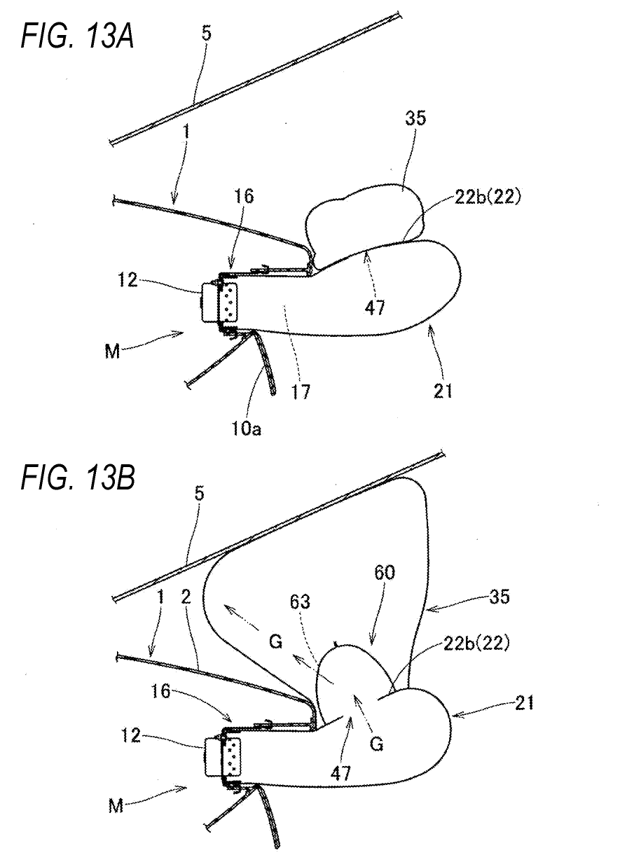

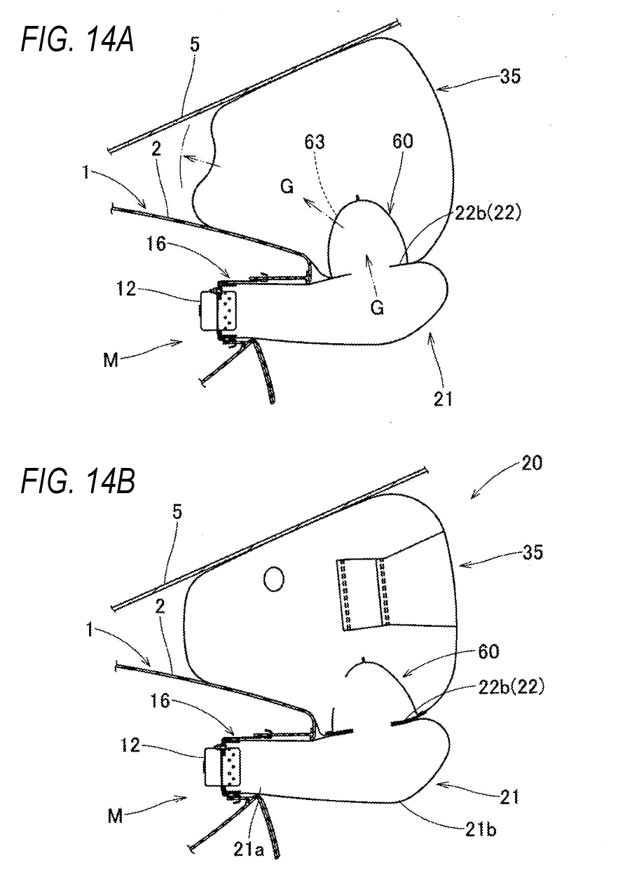

In the airbag device M according to the embodiment, the airbag 20 includes the upper inflation portion 35 and the lower inflation portion 21 which are formed in separate bag shapes and communicate with each other via the communication hole 47, and the upper inflation portion 35 is configured to be inflated by causing the inflation gas G flowing into the lower inflation portion 21 to flow therein via the communication hole 47. In addition, the upper inflation portion 35 and the lower inflation portion 21 are coupled each other by being joined to each other at a peripheral edge portion of the communication hole 47. That is, in the airbag device M of the embodiment, in an initial stage of inflation of the airbag 20, first, the lower inflation portion 21 is inflated so as to protrude rearward from the case 16 as the storage portion by causing the inflation gas discharged from the inflator 12 to flow therein, and then the upper inflation portion 35 is inflated by causing the inflation gas to flow therein through the communication hole 47. When the upper inflation portion 35 is inflated, the inflation of the lower inflation portion 21 is substantially full, and in the lower inflation portion 21, the upper surface side (the rear upper portion 22b in the peripheral wall portion 22), which is a surface on the upper inflation portion 35 side (the area constituting the periphery of the communication hole 47), is disposed to be inclined rearward and upward with respect to the horizontal direction as viewed from the left and right sides. Therefore, the upper inflation portion 35 can be inflated so as to protrude forward and upward by being pushed by the upper surface of the lower inflation portion 21 (the area of the periphery of the communication hole 47, that is, the rear upper portion 22b of the peripheral wall portion 22), and can be quickly brought into contact with the front windshield 5 and the upper surface 2 of the instrument panel 1. To describe a deployment behavior of the airbag 20 according to the embodiment in detail, at the initial stage of inflation of the airbag 20, first, the lower inflation portion 21 into which the inflation gas flows protrudes rearward from the protrusion opening 17 of the case 16, thereby substantially achieving the full inflation (see FIG. 13A). Thereafter, when the upper inflation portion 35 is inflated by causing the inflation gas to flowing therein through the communication hole 47, the upper inflation portion 35 protrudes forward and upward so as to be pushed by the upper surface of the lower inflation portion 21 (the rear upper portion 22b of the peripheral wall portion 22) disposed to be inclined rearward and upward, and the inflation gas G is regulated by the flow regulating fabric 60 and flows into the inside of the upper inflation portion 35 so as to flow forward and upward, so that the upper inflation portion 35 is inflated while being deployed toward a vehicle front side as shown in FIG. 13B. As shown in FIGS. 14A and 14B, the upper inflation portion 35 is fully inflated by filling a gap between the instrument panel 1 and the front windshield 5 after completing the contact with the upper surface 2 of the instrument panel 1 and the front windshield 5.

Further, even after the airbag 20 is fully inflated, since the lower inflation portion 21 supporting the rear lower surface side (the rear portion 39b of the lower wall portion 39) of the upper inflation portion 35 inclines the upper surface (the rear upper portion 22b of the peripheral wall portion 22) in contact with the upper inflation portion 35 rearward and upward with respect to the horizontal direction (see FIGS. 15 and 16), the inclination of the upper surface (the rear upper portion 22b of the peripheral wall portion 22) of the lower inflation portion 21 causes a force that inclines the entire upper inflation portion forward and downward (causes the front end to be directed downward) to act on the upper inflation portion 35 that has be fully inflated, and the upper inflation portion 35 is pressed against the upper surface 2 side of the instrument panel 1 over the area on the front end 35aa side at the time of full inflation. Therefore, a front lower surface of the upper inflation portion 35 (the front portion 39a of the lower wall portion 39) can be stably abutted against the upper surface 2 of the instrument panel 1 over the entire area in the front-rear direction. In particular, in the airbag device M according to the embodiment, the separation distance D1 between the front end (inflow opening 26) of the lower inflation portion 21 and the front portion 39a of the lower wall portion 39 in the upper inflation portion 35 when the airbag 20 in a state of being inflated alone is viewed from the left-right direction side is set to be smaller than the separation distance D2 between the inflow opening 26 (that is, the front end of the case 16) of the airbag 20 and the front portion 39a of the lower wall portion 39 of the upper inflation portion 35 (that is, the upper surface 2 of the instrument panel 1) when the airbag 20 in a state of being mounted on the vehicle is viewed from the left-right direction side. That is, in the airbag device M according to the embodiment, in the state where the airbag device is mounted on the vehicle, the airbag 20 is inflated by pushing open the gap between the lower inflation portion 21 and the upper inflation portion 35, and the upper inflation portion 35 presses a front lower surface side (the front portion 39a in the lower wall portion 39) strongly against (strongly interferes with) the upper surface 2 of the instrument panel 1, thereby achieving the full inflation. Therefore, when the upper inflation portion 35 is fully inflated, a contact state with the upper surface 2 of the instrument panel 1 can be stably maintained. Further, in the airbag 20 according to the embodiment, since the front end 35aa of the upper inflation portion 35 at the time of full inflation is disposed in front of the front end (inflow opening 26) of the lower inflation portion 21, such a strong interference state of the front lower surface side of the upper inflation portion 35 with the upper surface 2 of the instrument panel 1 can be maintained more stably.

In the airbag device M according to the embodiment, since the lower inflation portion 21 is formed of a bag body separate from the upper inflation portion 35, the upper inflation portion 35 can be supported by bringing the areas of the periphery of the communication hole 47 (specifically, areas on an outer peripheral side of the sewn portion 48) into contact with each other at the time of full inflation. Since the area of the lower inflation portion 21 on the rear end side (the rear area 21b) at the time of full inflation is thicker than the area on the front end side (the front area 21a), the rear lower surface side (the rear portion 39b of the lower wall portion 39) of the upper inflation portion 35 can be stably supported by the rear area 21b inflated to be thick, and the upper inflation portion 35 can also be prevented from moving so as to collapse rearward and downward in a state before the occupant is received.

That is, in the airbag device M according to the embodiment, even in a configuration in which the airbag 20 is stored on the lower portion 1a side of the instrument panel 1 and is inflated so as to be deployed forward and upward while protruding rearward, the upper inflation portion 35 of the airbag 20 can be quickly inflated so as to abut against the upper surface 2 of the instrument panel 1 and the front windshield 5, the contact state with the upper surface 2 of the instrument panel 1 can be stably maintained when the upper inflation portion 35 is fully inflated, and the upper inflation portion 35 can also be prevented from moving so as to collapse rearward and downward after the full inflation. As a result, the upper body MU of the occupant MP can be stably protected by the upper inflation portion 35 supported by the upper surface 2 of the instrument panel 1, the front windshield 5, and the lower inflation portion 21.

Therefore, in the airbag device M according to the embodiment, even in a configuration in which the airbag is stored on the lower portion 1a side of the instrument panel 1, the occupant MP can be accurately protected by the airbag 20 that has been fully inflated.

In the airbag device M according to the embodiment, the left wall portion 40 and the right wall portion 41 of the upper inflation portion 35 are implemented by the pair of left and right upper wall panels 76L, 76R, and the left wall portion 23 and the right wall portion 24 of the lower inflation portion 21 are implemented by the pair of left and right lower wall panels 86L, 86R. The separation distance D7 from the point P2 of the lower wall panels 86L, 86R on which the center of the communication hole 47 is projected to the rear edge 86a of the lower wall panels 86L, 86R in the state of being flatly deployed is set to be larger than the separation distance D6 from the point P1 of the upper wall panels 76L, 76R on which the center of the communication hole 47 is projected to the rear edge 76a of the upper wall panels 76L, 76R in the state of being flatly deployed. That is, in the airbag device M according to the embodiment, the lower inflation portion 21 can widely cover the area located behind the communication hole 47 on the rear lower surface side of the upper inflation portion 35 at the time of full inflation over the rear end by making the area located behind the communication hole 47 wider in the front-rear direction at the time of full inflation. In other words, the area on the rear lower surface side of the upper inflation portion 35 (the rear portion 39b of the lower wall portion 39) can be supported widely in the front-rear direction toward a rear end 39ba by the lower inflation portion 21. That is, even when the area on the rear end 39ba side of the rear portion 39b moves downward, the upper inflation portion 35 can be stably supported by the area on the rear end 22ba side of the rear upper portion 22b of the peripheral wall portion 22 (see a two-dot chain line in FIG. 16), and thus it is possible to more accurately prevent a behavior of the upper inflation portion 35 moving so as to collapse rearward and downward in the state before the occupant is received. If such a point is not taken into consideration, the lower wall panel may be configured such that the separation distance from the point of the lower wall panel on which the center of the communication hole is projected to the rear end of the lower wall panel is equal to or smaller than the separation distance from the point of the upper wall panel on which the center of the communication hole is projected to the rear end of the upper wall panel.

In the airbag device M according to the embodiment, the upper inflation portion 35 has the flow regulating fabric 60 therein. The flow regulating fabric 60 covers the periphery of the communication hole 47 to be capable of regulating the flow of the inflation gas flowing into the upper inflation portion 35 through the communication hole 47. The flow regulating fabric 60 is formed in a substantially tubular shape to cover the upper side of the communication hole 47 while opening both left and right end sides. A front surface side of the flow regulating fabric 60 is provided with the gas outflow hole 63 through which the inflation gas flows out. Therefore, since the inflation gas flowing into the upper inflation portion 35 through the communication hole 47 can be prevented from flowing rearward and can flow forward and upward, the upper inflation portion 35 can be more quickly inflated so as to protrude forward and upward, and start of contact with the front windshield 5 or the upper surface 2 of the instrument panel 1 can be accelerated. Further, since the inflation gas G flowing into the upper inflation portion 35 is prevented from flowing rearward by the flow regulating fabric 60, it is possible to prevent the upper inflation portion 35 from being inflated so as to greatly protrude toward the rear side which is the occupant MP side. Therefore, the upper inflation portion 35 can be prevented from swinging in the front-rear direction when deployed, and can be quickly fully inflated so as to protect the occupant MP. If such a point is not taken into consideration, the flow regulating fabric may not be disposed inside the upper inflation portion.

What is claimed is:

1. A passenger seat airbag device comprising:
a storage portion disposed on a lower side of an instrument panel in a vehicle;
an airbag to be folded and stored in the storage portion; and
an inflator configured to supply inflation gas to the airbag, wherein
the airbag into which the inflation gas flows is inflated to protrude rearward from the storage portion and be deployed forward and upward,
the airbag includes a lower inflation portion connected to the inflator and configured to be inflated to protrude rearward from the storage portion, and an upper inflation portion communicated with the lower inflation portion via a communication hole and configured to be inflated on an upper side of the lower inflation portion, in which the lower inflation portion and the upper inflation portion are formed in separate bag shapes, and the lower inflation portion and the upper inflation portion are configured to be coupled each other by being joined to each other at a peripheral edge portion of the communication hole,
the upper inflation portion is a portion that protects an upper body of an occupant seated in a passenger seat, and is configured, at a time of full inflation, such that a front lower surface side is abutted against the instrument panel, an upper surface side is abutted against a front windshield disposed above the instrument panel, and an area on a rear lower surface side constituting a periphery of the communication hole is supported by the lower inflation portion, and
the lower inflation portion is configured such that an area on a rear end side at the time of full inflation is thicker than an area on a front end side located on a side of the storage portion, and an upper surface supporting the area on the rear lower surface side of the upper inflation portion is inclined rearward and upward with respect to a horizontal direction at the time of full inflation as viewed from left and right sides.

2. The passenger seat airbag device according to claim 1, wherein
the upper inflation portion includes a pair of left and right upper wall panels disposed to face each other in a left-right direction side at the time of full inflation,
the lower inflation portion includes a pair of left and right lower wall panels disposed to face each other in the left-right direction side at the time of full inflation, and
a separation distance from a point of the lower wall panel on which a center of the communication hole is projected to a rear edge of the lower wall panel in a state of being flatly deployed is set to be larger than a separation distance from a point of the upper wall panel on which the center of the communication hole is projected to a rear edge of the upper wall panel in a state of being flatly deployed.

3. The passenger seat airbag device according to claim 1, wherein
the upper inflation portion has a flow regulating fabric therein, the flow regulating fabric covering a periphery of the communication hole to regulate a flow of the inflation gas flowing into the upper inflation portion through the communication hole, and
the flow regulating fabric is formed in a substantially tubular shape to cover an upper side of the communication hole while opening both left and right end sides, and a front surface side of the flow regulating fabric is provided with a gas outflow hole through which the inflation gas flows out.

4. The passenger seat airbag device according to claim 2, wherein
the upper inflation portion has a flow regulating fabric therein, the flow regulating fabric covering a periphery of the communication hole to regulate a flow of the inflation gas flowing into the upper inflation portion through the communication hole, and
the flow regulating fabric is formed in a substantially tubular shape to cover an upper side of the communication hole while opening both left and right end sides, and a front surface side of the flow regulating fabric is provided with a gas outflow hole through which the inflation gas flows out.
